(19) United States
(12) Patent Application Publication
(10) Pub. No.: US 2013/0117437 A1
(43) Pub. Date: May 9, 2013

(54) METHOD FOR ESTABLISING TCP CONNECTING ACCORDING TO NAT BEHAVIORS

(71) Applicants: Chien-Chao TSENG, Hsinchu City (TW); Chia-Liang Lin, Pingtung City (TW); Kun-Ying Liu, Douliu City (TW); Cheng-Yuan Ho, Taipei City (TW)

(72) Inventors: Chien-Chao TSENG, Hsinchu City (TW); Chia-Liang Lin, Pingtung City (TW); Kun-Ying Liu, Douliu City (TW); Cheng-Yuan Ho, Taipei City (TW)

(73) Assignee: D-Link Corporation, Taipei City (TW)

(21) Appl. No.: 13/347,793

(22) Filed: Jan. 11, 2012

(30) Foreign Application Priority Data
Nov. 9, 2011 (TW) 100140891

(51) Int. Cl. G06F 15/16

(52) U.S. Cl. 709/224

(57) ABSTRACT

The present invention is to provide a method for establishing TCP connection according to NAT (Network Address Translation) behaviors, which is applied to a network system having a NBA (NAT Behavior Aware Server) located in the Internet and connected to two NATs in two private networks respectively. The method enables two network devices in the respective private networks to send testing messages to the NBA via the respective NATs. In response, the NBA sends reply messages to each network device to test the behaviors of the NATs respectively. Afterward, each network device generates a test result message according to each behavior of the corresponding NAT and sends the same to the NBA. Based on the test result messages, the NBA selects an optimal traversal technique from candidate traversal techniques, thereby allowing the network devices to respectively and directly traverse the NATs and establish a direct TCP connection therebetween.

### FIELD OF THE INVENTION

The present invention relates to a method for passing through NAT (Network Address Translation), more particularly to a method for establishing a TCP (Transmission Control Protocol) connection between network devices in two different private networks according to NAT behaviors, which utilizes a NBA (NAT Behavior Aware Server) located in the Internet for testing the behaviors of NATs in the two different private networks and, based on test result messages, selecting an optimal traversal technique from candidate traversal techniques, thereby allowing the network devices to respectively and directly traverse the NATs and establish a direct TCP connection therebetween.

### BACKGROUND OF THE INVENTION

Peer-to-peer (hereinafter abbreviated as P2P) networking is nowadays a widely used technique whereby a user's network device (e.g., a desktop computer) can make direct connection with another user's network device through a P2P network so as to share and exchange files (e.g., pictures, music, videos), perform distributed computation, or work in cooperation, to name only a few P2P applications.

In use, however, P2P networking is faced with problems arising from network address translators (NATs). NATs are typically deployed at the border between a private network and a public network to deal with the running short of Internet Protocol (IP) addresses as a result of the rapid development of the Internet. The IP Network Address Translator, which is an Internet standard defined in RFC 1631, involves performing IP address conversion on packets sent by network devices in a private network, so as for multiple network devices in the private network to make Internet connections using a common public-network IP address. More specifically, when a data packet to be sent out from a private network reaches a NAT, the NAT converts the private-network IP address of the packet into a public-network IP address before sending out the packet. Likewise, when receiving an external packet, the NAT checks the public-network IP address of the packet against the information in a mapping table stored in the NAT, converts the public-network IP address into a private-network IP address accordingly, and then directs the packet to the corresponding network device in the private network.

As described above, NATs are configured for shielding private networks so that network devices in a private network behind a NAT are rendered invisible to public networks. And because of that, when two network devices which are behind different private-network NATs are to connect with each other by P2P networking, the mapping behaviors, filtering behaviors, and Transmission Control Protocol (TCP) state tracking behaviors typical of the NATs will prevent the network devices from directly establishing a connection path therebetween.

To solve this problem effectively, a Case Driven Call Setup (CDCS) method was proposed in related studies. The CDCS method is designed to enable NAT traversal using the User Datagram Protocol (UDP). With CDCS, a network device collects NAT information and achieves NAT traversal in various network environments by means of hole punching. For example, a first network device and a second network device collect NAT information of their respective private networks in advance and register with a proxy server for storing the NAT information collected. When the first and the second network devices are to communicate with each other, the first network device sends a message to the proxy server, which delivers the message to the second network device. At the same time, the proxy server finds the UDP public-end addresses of the first and the second network devices according to their NAT information and informs the two network devices of how to do hole punching. Thus, the network devices obtain the UDP public-end address of each other and establish connection for communication.

However, UDP is an unreliable connectionless transmission protocol in which no verification mechanism is used to ensure that data are correctly received, which does not require that lost data be resent or that data be received in order, and which has no feedback mechanism for controlling the speed of data flow. By contrast, TCP is a reliable connection-oriented transmission protocol whose state tracking feature not only requires the callee to send an acknowledgement to the caller upon receipt of data, but also requires both the callee and the caller to keep a record of sent packets as a basis of verification of the next entries of packet data. In addition, TCP has a timer mechanism by which a caller resends a sent packet upon determining the occurrence of transmission timeout, so as to ensure data integrity. Since the CDCS method is designed only for UDP-based NAT traversal and does not take into account such TCP features as state tracking, it is not applicable to TCP-based NAT traversal.

Notwithstanding, a good number of TCP-based NAT traversal techniques have been proposed, such as Establishment then SYN-in (hereinafter abbreviated as ESi), SYN with Normal-TTL (SNT), SYN with Low-TTL (SLT), and Relay. These NAT traversal techniques, however, are not applicable to each NAT, for NATs in different network environments have different properties. In order to establish a direct TCP-based connection path between two network devices via their respective NATs, the most suitable NAT traversal technique to be used is usually determined by one of the following two approaches. The first approach is to perform a sequential connectivity check with initiator changes, in which two network devices test the aforementioned NAT traversal techniques sequentially until one capable of establishing a connection path is found. As this connectivity check is time-consuming, the users will have to wait for a long time. The second approach is to perform a parallel connectivity check with initiator changes, in which two network devices test the aforementioned NAT traversal techniques all at the same time until one capable of establishing a connection path is found. With the latter approach, a huge amount of data will be simultaneously exchanged between the network devices, thus leading to excessive use of network resources.

Hence, it is an important goal for network service providers to reduce the time required and the resources used for connectivity checks and to allow a TCP connection path to be rapidly established between two network devices by the optimal NAT traversal technique.

### BRIEF SUMMARY OF THE INVENTION

In view of the fact that the conventional methods for establishing TCP connection paths either require a long testing time or use considerable resources, the inventor of the present invention conducted extensive research and experiment and finally succeeded in developing a method for establishing TCP connection according to NAT behaviors. It is hoped that the present invention will enhance the competitiveness of service providers in the network service market.

It is an object of the present invention to provide a method for establishing TCP connection according to NAT behaviors. Basically, NAT information is obtained by testing, and the optimal traversal technique is selected according to the NAT information so as to shorten the users' waiting time and reduce the amount of network resources to be used. More particularly, two network devices which are located in different private networks each send a plurality of testing messages to a NAT behavior aware server (hereinafter abbreviated as NBA) in the Internet via their respective NATs. In response, the NBA sends the corresponding reply messages to each network device to test the behaviors of the NATs respectively. Afterward, each network device generates a test result message according to each behavior of the corresponding NAT and sends the test result messages to the NBA. Based on the information of the first and the second NATs thus obtained, the NBA selects the optimal traversal technique from a plurality of candidate traversal techniques, thereby allowing the first and the second network devices to respectively and directly traverse the first and the second NATs and establish a direct TCP connection between the two network devices. When these two network devices are to make TCP connection at a later time, a direct TCP connection can be rapidly established between them with the optimal traversal technique selected by the NBA, for the NBA has stored the information of the corresponding NATs.

It is another object of the present invention to provide the foregoing method, wherein upon obtaining the information of the first and the second NATs, the NBA sends the information of the NATs to the first and/or the second network device, and it is the first and/or the second network device receiving the NAT information that selects the optimal traversal technique from the plural candidate traversal techniques, so as for the first and the second network devices to establish a direct TCP connection therebetween. Thus, the load of the NBA can be lowered, and the information of the NATs will not occupy too much storage space in the NBA.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic view of a network system according to the present invention;

FIG. 2 is a time sequence diagram according to the present invention;

FIG. 3 is a time sequence diagram for testing mapping behaviors according to the present invention;

FIG. 4 is a time sequence diagram for testing ESi filtering behaviors according to the present invention;

FIG. 5 is a time sequence diagram for testing Si filtering behaviors according to the present invention;

FIG. 6 is a time sequence diagram for testing SoSi TCP state tracking behaviors according to the present invention;

FIG. 7 is a time sequence diagram for testing SoRiSi TCP state tracking behaviors according to the present invention;

FIG. 8 is a time sequence diagram for testing SoUiSi TCP state tracking behaviors according to the present invention;

FIG. 9 is a time sequence diagram for testing SoTiSi TCP state tracking behaviors according to the present invention;

FIG. 10 is a time sequence diagram of an ESi traversal technique according to the present invention;

FIG. 11 is a time sequence diagram of an SNT traversal technique according to the present invention; and

FIG. 12 is a time sequence diagram of an SLT traversal technique according to the present invention.

### DETAILED DESCRIPTION OF THE INVENTION

The Case Driven Call Setup (CDCS) method is targeted at User Datagram Protocol (UDP)-based network address translator (NAT) traversal and therefore not suitable for use with the Transmission Control Protocol (TCP). Moreover, the NAT information collected by CDCS includes only the NAT type, and the NAT type is divided by CDCS only into the full-cone NAT, the non full-cone NAT, and the symmetric NAT. The non full-cone NAT, however, can be further sorted by its filtering behavior into the address-restricted cone NAT and the port-restricted cone NAT. The hole punching processes of the latter two types of NATs may vary, given their different restrictions, and yet CDCS does not allow for such NAT types and hence leaves much to be desired. In consideration of the above, the inventor of the present invention studied the technical means of CDCS as well as the state tracking feature of TCP and came up with a novel technique for TCP connection-oriented NAT traversal as disclosed herein.

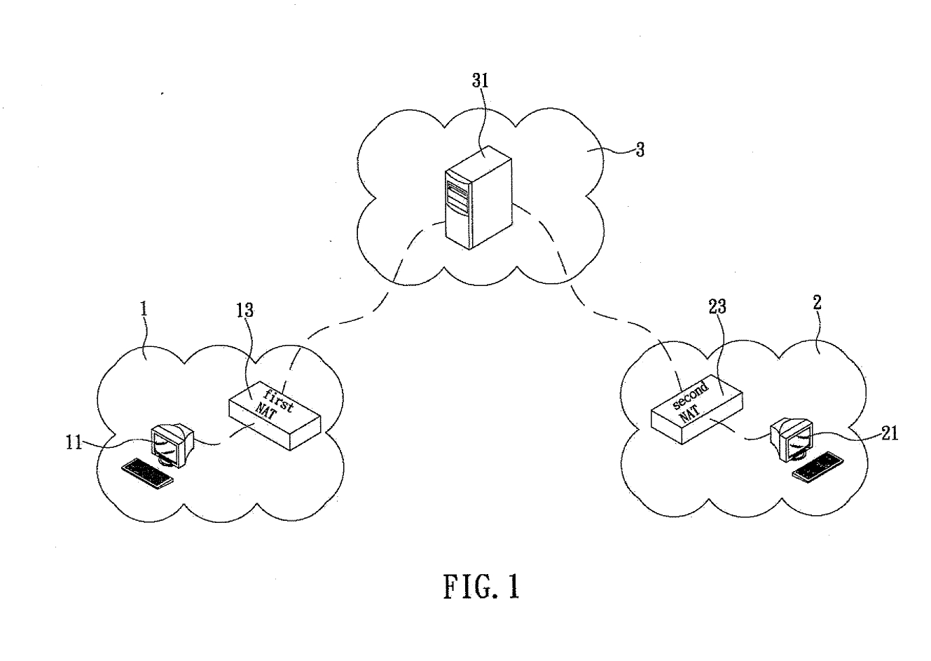

The present invention discloses a method for establishing TCP connection according to NAT behaviors. In a preferred embodiment of the present invention, referring to FIG. 1, a network system includes a first private network 1, a first network device 11 (e.g., a computer), a first NAT 13, a second private network 2, a second network device 21, a second NAT 23, and a NAT behavior aware server (hereinafter abbreviated as NBA) 31. The first network device 11 and the first NAT 13 are located in the first private network 1 and connected to each other. The first network device 11 can send and receive packet messages to and from computers, servers, etc. in the Internet 3 via the first NAT 13. Similarly, the second network device 21 and the second NAT 23 are located in the second private network 2 and connected to each other. The second network device 21 can send and receive packet messages to and from computers, servers, etc. in the Internet 3 via the second NAT 23. The NBA 31 is located in the Internet 3 and can be connected with the first NAT 13 and the second NAT 23 respectively so as to send and receive packet messages thereto and therefrom.

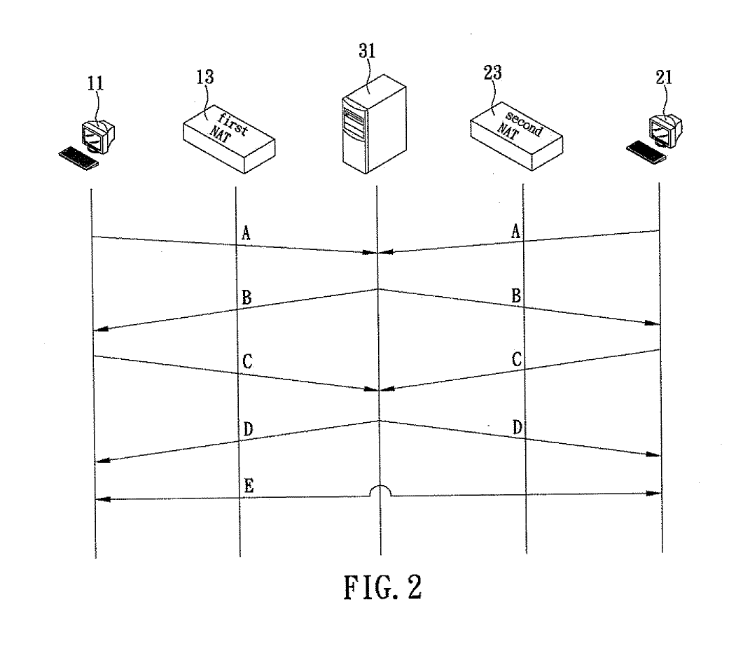

Referring to FIGS. 1 and 2, before the first network device 11 and the second network device 21 make their first ever direct TCP connection with each other, each of the first network device 11 and the second network device 21 sends a plurality of testing messages via the corresponding NAT 13, 23 to the NBA 31 (as indicated by the arrows A in FIG. 2) in order to test a plurality of behaviors (e.g., mapping behaviors, filtering behaviors, etc.). Upon receiving the testing messages and according to the contents thereof, the NBA 31 sends the corresponding reply messages to the first network device 11 and the second network device 21 respectively (as indicated by the arrows B in FIG. 2), thereby testing the behaviors of the NATs 13, 23. Then, each of the first network device 11 and the second network device 21 generates test result messages according to whether each corresponding reply message is received and according to the contents of each reply message received. After that, the test result messages are sent to the NBA 31 by the first network device 11 and the second network device 21 (as indicated by the arrows C in FIG. 2). The NBA 31 receives the test result messages, reads therefrom information of the NATs 13, 23, and stores the information read. Meanwhile, the NBA 31 identifies the behavior (e.g., mapping behavior, filtering behavior, etc.) of each NAT 13, 23 according to the information of the NATs 13, 23 and selects the optimal traversal technique from a plurality of candidate traversal techniques (e.g., ESi, SNT, SLT, and Relay). Based on the selection, the NBA 31 generates a traversal message for each of the first network device 11 and the second network device 21 and sends the traversal messages to the network devices 11, 21 respectively (as indicated by the arrows D in FIG. 2). Once receiving the corresponding traversal messages and according to the contents thereof, the first network device 11 and the second network device 21 traverse the first NAT 13 and the second NAT 23 respectively. Thus, TCP connection between the first network device 11 and the second network device 21 is established (as indicated by the two-headed arrow E in FIG. 2).

Referring again to FIG. 1, according to the method of the present invention, the NBA 31 obtains information of the first NAT 13 and of the second NAT 23 prior to the first establishment of TCP connection between the first network device 11 and the second network device 21. Also, the NBA 31 is configured to select the optimal traversal technique from a plurality of candidate traversal techniques according to the information of the first NAT 13 and of the second NAT 23. Thus, when the first network device 11 and the second network device 21 are to make TCP connection for a second time, the NBA 31 can generate the corresponding traversal messages immediately and send them to the first network device 11 and the second network device 21 to enable rapid establishment of a direct TCP connection between the network devices 11, 21. As a result, either the time required for connectivity checks is shortened for each connection, or the amount of messages generated during repeated tests is reduced.

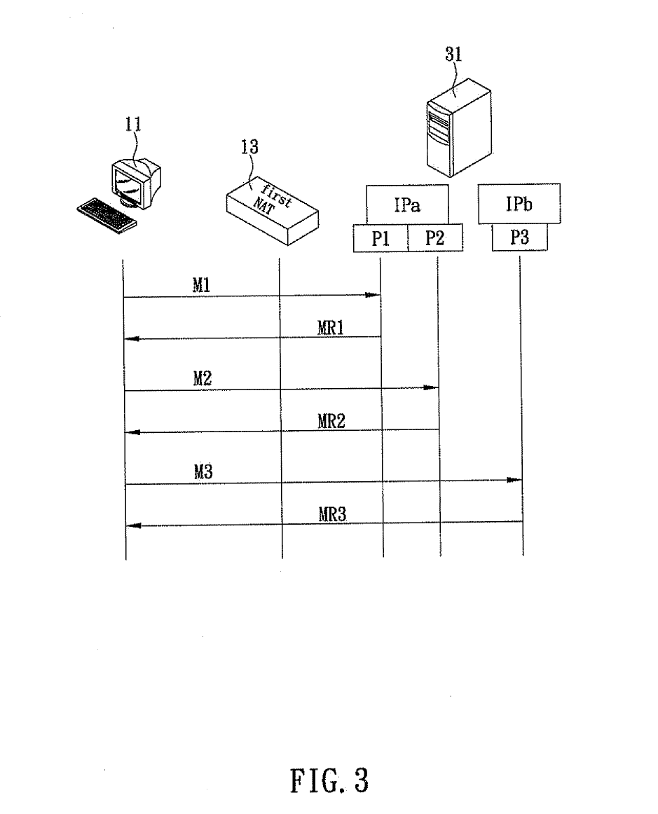

In order to specifically disclose the foregoing technical features, a detailed description of how behavioral tests are performed between the network devices 11, 21 and the NBA 31 and how NAT information is obtained is given below with particular reference to the first network device 11 and the first NAT 13. The NBA 31 is provided with a network interface having two public Internet Protocol (IP) addresses, namely IPa and IPb. IPa opens two sockets which use a first port P1 and a second port P2 respectively. IPb opens one socket which uses a third port P3. As such, the NBA 31 can send and receive packets through the ports P1, P2, P3. To begin with, referring to FIGS. 1 and 3, a mapping behavior test is conducted by the first network device 11 and the NBA 31 as follows. According to the public IP addresses IPa and IPb, the first network device 11 sends three binding requests through the first NAT 13 to the first port P1, the second port P2, and the third port P3 respectively (as indicated by the arrows M1, M2, and M3 in FIG. 3). Upon receipt of the binding requests, the NBA 31 sends three binding responses to the first network device 11 in reply, wherein the binding responses are sent via the first port P1, the second port P2, and the third port P3 respectively (as indicated by the arrows MR1, MR2, and MR3 in FIG. 3). Then, based on the three binding responses replied from the NBA 31, the first network device 11 determines whether the mapping behavior of the first NAT 13 is independent, address dependent, or port and address dependent. For example, if the first NAT 13 uses a single port of its own to communicate with all the ports P1, P2, P3, it can be known that the mapping behavior of the first NAT 13 has nothing to do with the identities of external ports and is hence independent; if the first NAT 13 uses a single port of its own to communicate with the ports P1, P2 and another port of its own to communicate with the port P3, then the mapping behavior of the first NAT 13 is related to external IP addresses and hence address dependent; and if the first NAT 13 uses different ports of its own to communicate with the ports P1, P2, P3 respectively, the mapping behavior of the first NAT 13 is related to both external IP addresses and external ports, i.e., port and address dependent.

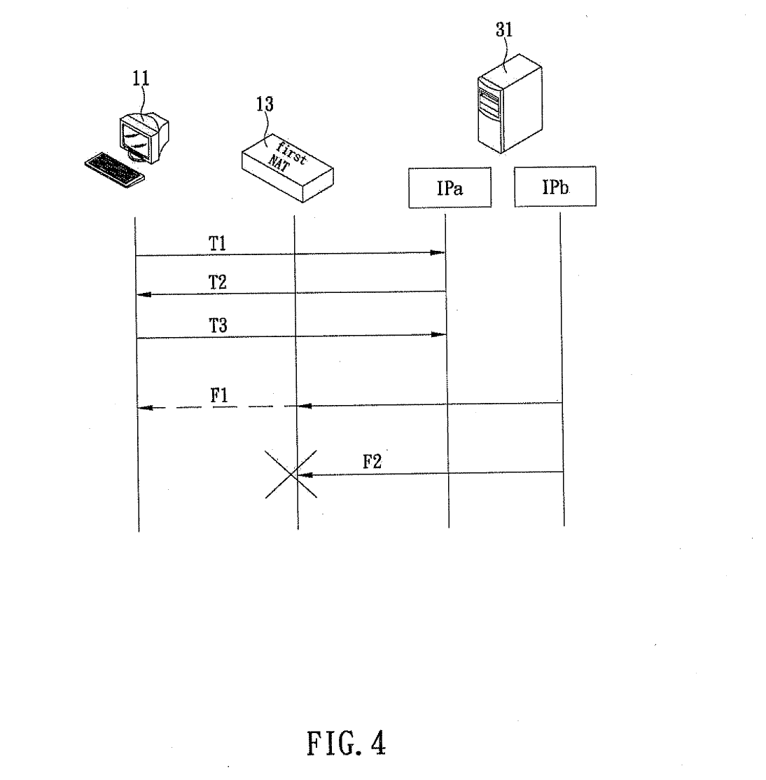

Furthermore, two filtering behavior tests (also known as TCP filtering behavior tests) are conducted by the first network device 11 and the NBA 31. These two tests are the ESI (Establishment then SYN-in) filtering behavior test and the Si (SYN-in) filtering behavior test. To perform the ESi filtering behavior test, referring to FIGS. 1 and 4, the first network device 11 begins by making TCP connection with the public IP address IPa of the NBA 31 via three-way handshake. As three-way handshake is well known in the art, the connection process is described only briefly as follows. To start with, the first network device 11 sends a Synchronize/Start (or SYN for short) packet to the NBA 31 through the first NAT 13 (as indicated by the arrow T1 in FIG. 4). Then, the NBA 31 sends a SYN-ACK packet to the first network device 11 (as indicated by the arrow T2 in FIG. 4), wherein ACK stands for “acknowledgement”. In response to that, the first network device 11 sends an ACK packet to the NBA 31 (as indicated by the arrow T3 in FIG. 4). Next, the NBA 31 sends a SYN packet from the public IP address IPb to the first network device 11. Since the first NAT 13 will use a port of its own to deliver network packets once TCP connection is established between the first network device 11 and the public IP address IPa of the NBA 31, the SYN packet sent by the NBA 31 is supposed to leave the first NAT 13 through the port thereof that is used to make the aforesaid TCP connection (between the first network device 11 and the public IP address IPa of the NBA 31). If the first network device 11 receives the SYN packet sent from the public IP address IPb of the NBA 31 (as indicated by the arrow F1 in FIG. 4), it means that the filtering behavior of the first NAT 13 allows such a packet sequence as “establishment then inbound SYN” (i.e., establishment then SYN-in). If the first network device 11 does not receive the SYN packet sent from the public IP address IPb of the NBA 31 (as indicated by the arrow F2 in FIG. 4), it can be known that the filtering behavior of the first NAT 13 does not allow the packet sequence of “establishment then inbound SYN”.

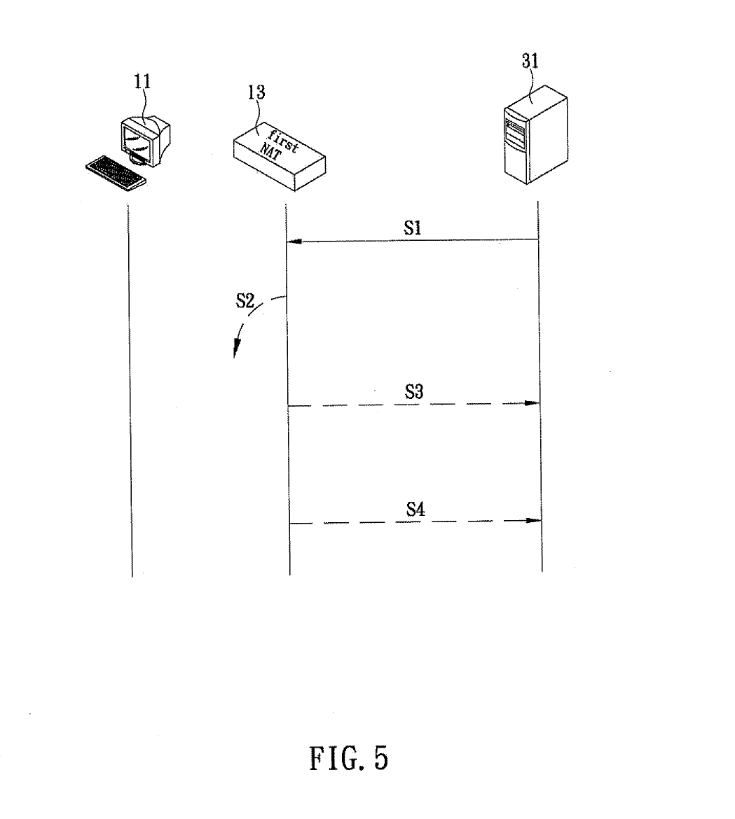

After the BSi filtering behavior test is performed on the first NAT 13, the Si filtering behavior test is conducted as follows. Referring to FIGS. 1 and 5, the NBA 31 sends a SYN packet to an unopened port of the first NAT 13 (as indicated by the arrow Si in FIG. 5). Now that this port of the first NAT 13 is not yet opened, the first NAT 13 will not deliver the SYN packet to the first network device 11 but will handle the SYN packet by itself. For instance, the first possible approach to handling the SYN packet is to drop it directly (as indicated by the arrow S2 in FIG. 5), the second possible approach is for the first NAT 13 to send a Reset (RST) request to the NBA 31 in reply (as indicated by the arrow S3 in FIG. 5), and the third possible approach is for the first NAT 13 to reply to the NBA 31 with an ICMP Host Unreachable packet (as indicated by the arrow S4 in FIG. 5). By determining which of the three possible approaches is used, the Si filtering behavior test result of the first NAT 13 is obtained.

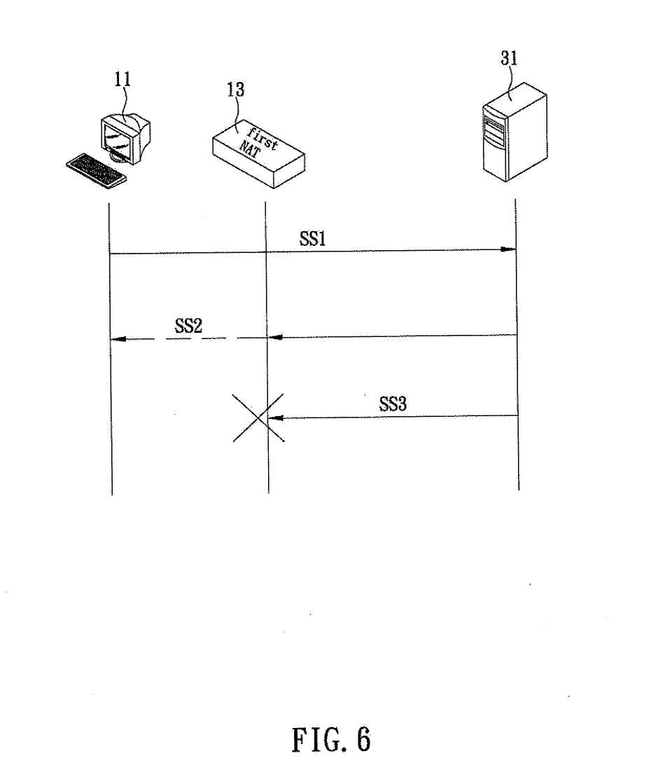

In addition, four TCP state tracking behavior tests are conducted by the first network device 11 and the NBA 31, and these four tests are the SoSi (SYN-out SYN-in) TCP state tracking behavior test, the SoRiSi (SYN-out RST-in SYN-in) TCP state tracking behavior test, the SoUiSi (SYN-out UNR-in SYN-in) TCP state tracking behavior test, and the SoTiSi (SYN-out TTL-in SYN-in) TCP state tracking behavior test. To conduct the SoSi TCP state tracking behavior test, referring to FIGS. 1 and 6, the first network device 11 sends a first SYN packet to the NBA 31 through the first NAT 13 (as indicated by the arrow SS1 in FIG. 6). Upon receiving the first SYN packet, the NBA 31 replies to the first network device 11 with a second SYN packet, which is to be delivered through the first NAT 13. If the first network device 11 receives the second SYN packet (as indicated by the arrow SS2 in FIG. 6), it means that the first NAT 13 allows such a packet sequence as “SYN-out SYN-in”. If the first network device 11 does not receive the second SYN packet (as indicated by the arrow SS3 in FIG. 6), meaning the first NAT 13 does not deliver the second SYN packet from the NBA 31 to the first network device 11, it can be known that the first NAT 13 does not allow the packet sequence of “SYN-out SYN-in”.

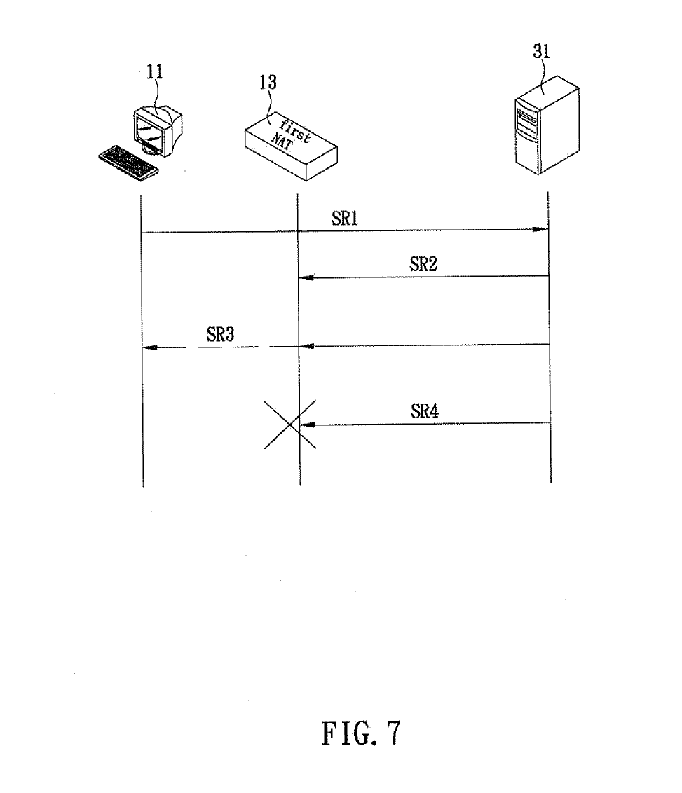

The SoRiSi TCP state tracking behavior test is performed by the first network device 11 and the NBA 31 in the following manner. Referring to FIGS. 1 and 7, the first network device 11 sends a third SYN packet to the NBA 31 through the first NAT 13 (as indicated by the arrow SR1 in FIG. 7). Upon receiving the third SYN packet, the NBA 31 sends a RST packet to the first NAT 13 (as indicated by the arrow SR2 in FIG. 7) and then replies to the first network device 11 with a fourth SYN packet, which is to be delivered through the first NAT 13. If the first network device 11 receives the fourth SYN packet (as indicated by the arrow SR3 in FIG. 7), it means that the first NAT 13 allows such a packet sequence as “SYN-out RST-in SYN-in”. If the first network device 11 does not receive the fourth SYN packet (as indicated by the arrow SRA in FIG. 7), it means that the first NAT 13 does not allow the packet sequence of “SYN-out RST-in SYN-in”.

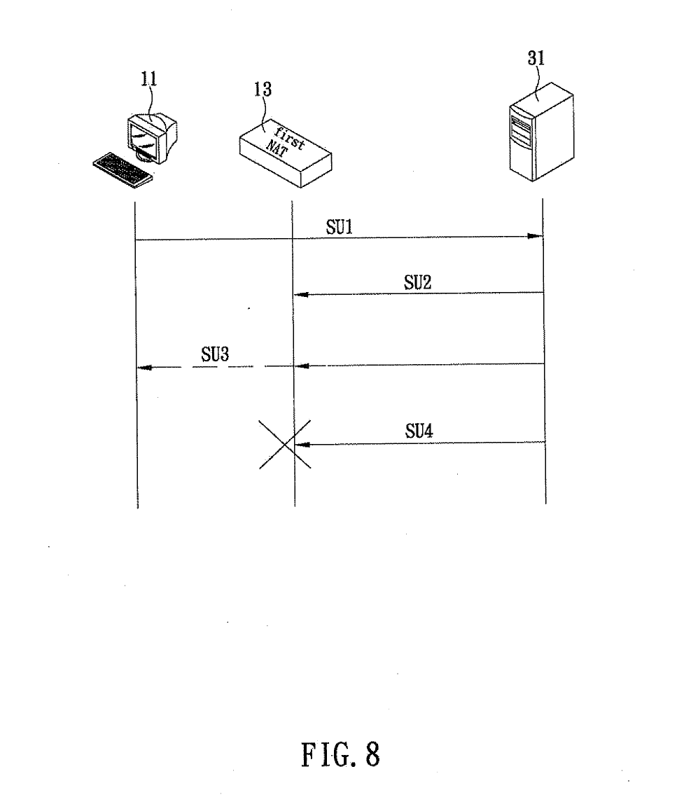

Following that, the first network device 11 and the NBA 31 perform the SoUiSi TCP state tracking behavior test. As shown in FIGS. 1 and 8, the first network device 11 sends a fifth SYN packet through the first NAT 13 to the NBA 31 (as indicated by the arrow SU1 in FIG. 8). Once receiving the fifth SYN packet, the NBA 31 sends an ICMP Host Unreachable packet to the first NAT 13 (as indicated by the arrow SU2 in FIG. 8) and then replies to the first network device 11 with a sixth SYN packet, which is to be delivered through the first NAT 13. If the first network device 11 receives the sixth SYN packet (as indicated by the arrow SU3 in FIG. 8), it means that the first NAT 13 allows such a packet sequence as “SYN-out UNR-in SYN-in”. If the network device 11 does not receive the sixth SYN packet (as indicated by the arrow SU4 in FIG. 8), it can be inferred that the first NAT 13 does not allow the packet sequence of “SYN-out UNR-in SYN-in”.

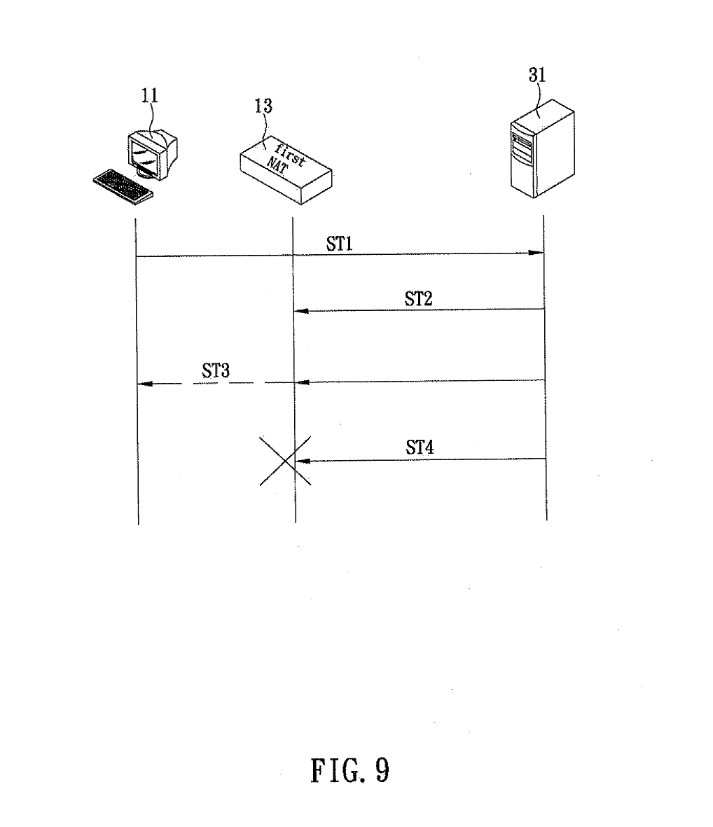

Last but not least, the SoTiSi TCP state tracking behavior test is performed between the first network device 11 and the NBA 31 in the following manner. Referring to FIGS. 1 and 9, the first network device 11 sends a seventh SYN packet to the NBA 31 via the first NAT 13 (as indicated by the arrow ST1 in FIG. 9). The NBA 31, upon receiving the seventh SYN packet, sends an ICMP TTL (Time-to-Live)-Expired packet to the first NAT 13 (as indicated by the arrow ST2 in FIG. 9) and then replies to the first network device 11 with an eighth SYN packet, which is to be delivered through the first NAT 13. If the first network device 11 receives the eighth SYN packet (as indicated by the arrow ST3 in FIG. 9), it means that the first NAT 13 allows such a packet sequence as “SYN-out TTL-in SYN-in”. If the first network device 11 does not receive the eighth SYN packet (as indicated by the arrow ST4 in FIG. 9), it means that the first NAT 13 does not allow the packet sequence of “SYN-out TTL-in SYN-in”. Once the mapping behavior test, the filtering behavior tests, and the TCP state tracking behavior tests are completed, the first network device 11 obtains behavioral information of the first NAT 13 and generates the corresponding test result messages. By the same token, the second network device 21 can obtain behavioral information of the second NAT 23 through the foregoing behavioral tests and generate the corresponding test result messages. The first network device 11 and the second network device 21 send the test result messages to the NBA 31.

Referring back to FIG. 1, the NBA 31 receives the test result messages, reads the information of the first and the second NATs 13, 23 in the test result messages, and stores the information read. Based on the information of the NATs 13, 23, the NBA 31 determines which traversal technique the network devices 11, 21 should use and which one of the network devices 11, 21 should be the first to send a SYN packet in order to make connection. Afterward, the NBA 31 generates traversal messages according to the aforesaid information and sends the traversal messages to the first network device 11 and the second network device 21 respectively, wherein each traversal message includes such contents as using the ESi traversal technique, the first network device 11 taking the initiative in making connection, etc. It should be pointed out however, that the contents of the traversal messages can be adjusted according to practical needs, and that the number and order of the aforesaid behavioral tests to be performed on the NATs 13, 23 may be changed to suit design requirements.

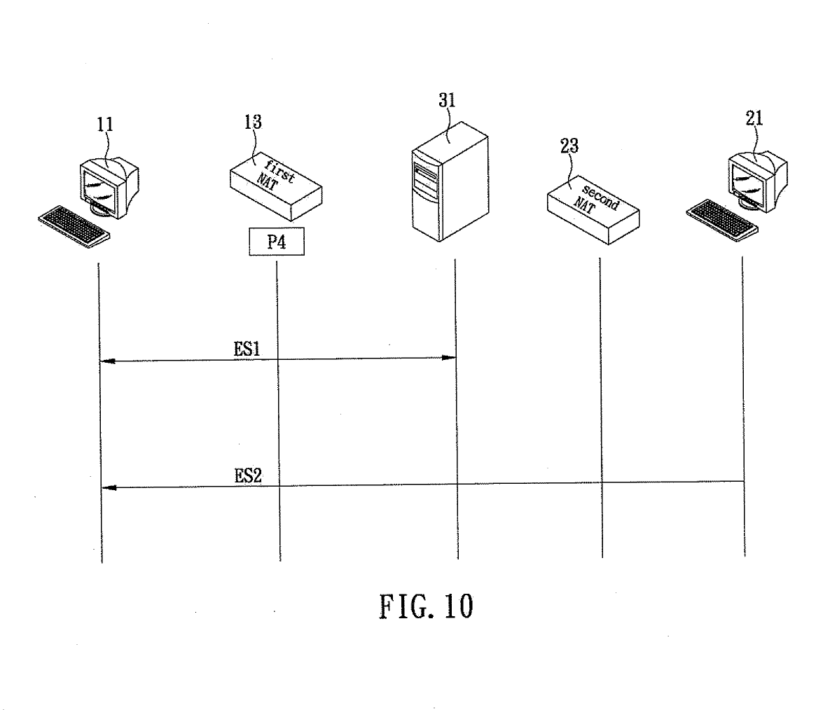

The traversal technique to be used varies with the information of the NATs 13, 23. Therefore, described below are only some examples of traversal techniques that are applicable to the present invention. The first applicable traversal technique is ESi (Establishment then SYN-in). Referring to FIGS. 1 and 10, when the filtering behavior of the first NAT 13 allows “establishment then inbound SYN” (i.e., establishment then SYN-in), the first network device 11 will establish TCP connection with the NBA 31 first (as indicated by the arrow ES1 in FIG. 10), causing the first NAT 13 to open a port P4 which is required for the mapping behavior, i.e., a port through which the first NAT 13 will send and receive packets. Then, the second network device 21 establishes a direct TCP connection with the first network device 11 by way of the port P4 (as indicated by the arrow ES2 in FIG. 10). As the ESi traversal technique can make direct use of the port P4 of the first NAT 13 and does not require the first NAT 13 to open another port, this traversal technique will be given the highest priority if the network devices 11, 21 are allowed to use one of several traversal techniques.

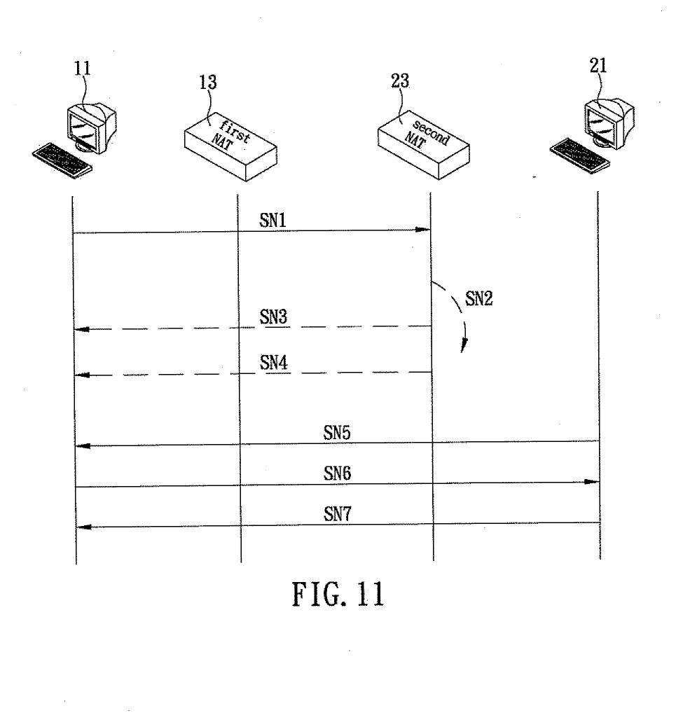

The second applicable traversal technique is SNT (SYN with Normal-TTL). Referring to FIGS. 1 and 11, the first network device 11 sends an ordinary SYN packet to the second network device 21 in an attempt to make TCP connection. This action also causes the first NAT 13 to open a port which is required for the mapping behavior. When the second NAT 23 subsequently receives an unexpected SYN packet (as indicated by the arrow SN1 in FIG. 11), the second NAT 23 may have one of the following three behaviors. The first possible behavior is to drop the SYN packet directly (as indicated by the arrow SN2 in FIG. 11), the second possible behavior is to reply to the first network device 11 with a RST packet (as indicated by the arrow SN3 in FIG. 11), and the third possible behavior is to reply to the first network device 11 with an ICMP Unreachable packet (as indicated by the arrow SN4 in FIG. 11). After that, the second network device 21 sends a SYN packet to the first network device 11 via the port of the first NAT 13 that has been used by the first network device 11 (as indicated by the arrow SN5 in FIG. 11). If the first NAT 13 does not block the port upon receiving the RST packet or the ICMP Unreachable packet, the first network device 11 will receive the SYN packet sent from the second network device 21 and, in reply, send a SYN-ACK packet to the second network device 21 (as indicated by the arrow SN6 in FIG. 11). The second network device 21 receives the SYN-ACK packet and replies with an ACK packet (as indicated by the arrow SN7 in FIG. 11), thereby establishing a direct TCP connection.

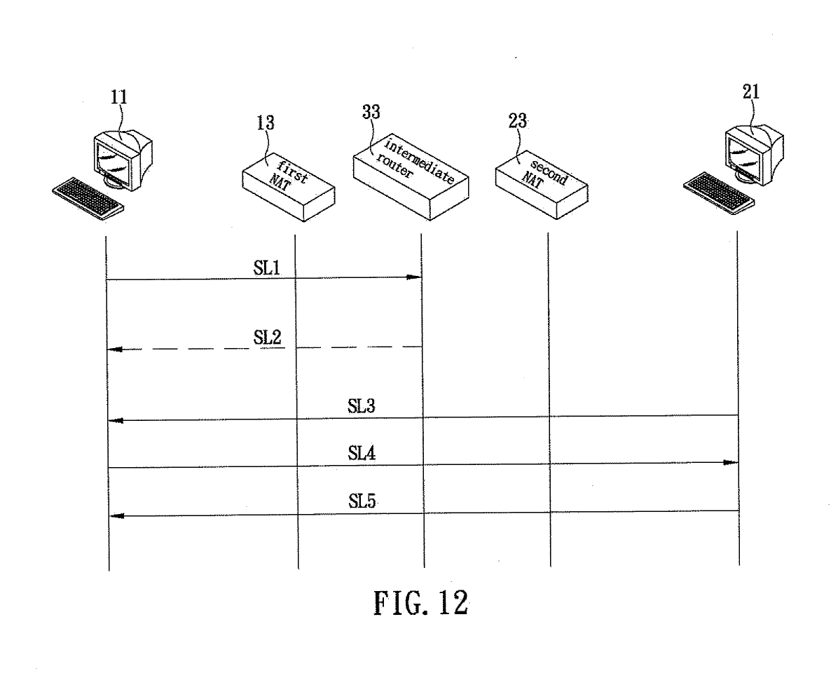

The third applicable traversal technique is SLT (SYN with Low-TTL). Referring to FIGS. 1 and 12, the first network device 11 sends out a SYN packet and thus opens a port of the first NAT 13 that is required for the mapping behavior. The time-to-live (TTL) of this SYN packet is generally set at a low value so that the SYN packet can pass through the first NAT 13 but cannot reach the second NAT 23 (as indicated by the arrow SL1 in FIG. 12). When an intermediate router 33 between the first NAT 13 and the second NAT 23 receives the SYN packet, the intermediate router 33 replies to the first network device 11 with an ICMP TTL-Expired packet (as indicated by the arrow SL2 in FIG. 12). If the first NAT 13 does not block the port upon receiving the ICMP TTL-Expired packet, the first network device 11 will receive a SYN packet sent by the second network device 21 (as indicated by the arrow SL3 in FIG. 12). In reply to the second network device 21, the first network device 11 sends out a SYN-ACK packet (as indicated by the arrow SL4 in FIG. 12), and then the second network device 21 replies to the first network device 11 with an ACK packet (as indicated by the arrow SL5 in FIG. 12). Thus, TCP connection is established. Since the first network device 11 is required in the SLT traversal technique to set the time-to-live of a SYN packet so that the SYN packet can traverse the first NAT 13 without reaching the second NAT 23, SLT is given a lower priority than SNT; in other words, SNT will be used in preference to SLT when both are applicable.

Referring to FIG. 1, the NBA 31, once in possession of the behavioral information of the first NAT 13 and of the second NAT 23, determines whether the first network device 11 or the second network device 21 can receive SYN packets by the ESI traversal technique; i.e., whether the filtering behavior of the first NAT 13 or of the second NAT 23 allows the packet sequence of “establishment then inbound SYN”. If it is the first network device 11 that can receive SYN packets (i.e., the first NAT 13 allows the packet sequence of “establishment then inbound SYN”), the ESi traversal technique will be adopted, and the second network device 21 will be instructed to send a SYN packet to the first network device 11. Likewise, if it is the second network device 21 that can receive SYN packets, the ESi traversal technique will be used, and the first network device 11 will be instructed to send a SYN packet to the second network device 21. If neither of the network devices 11, 21 can receive SYN packets by the ESi traversal technique, the NBA 31 will then determine whether the mapping behavior of the first NAT 13 or the second NAT 23 is randomly dependent. If yes, the first network device 11 and the second network device 21 can only use the Relay traversal technique, in which the first network device 11 and the second network device 21 send and receive data by way of a third-party server. The term “randomly dependent” refers to the NATs 13, 23 having either address-dependent or port-and-address-dependent mapping behaviors and opening ports randomly. For example, the NATs 13, 23 open ports 2000 to begin with, ports 2900 when it is necessary to open ports for a second time, and ports 1782 when it is necessary to open ports for a third time.

Referring again to FIG. 1, if the mapping behavior of neither the first NAT 13 nor the second NAT 23 is randomly dependent, the NBA 31 will determine, according to the Si filtering behavior test results of the NATs 13, 23, how the NATs 13, 23 will handle unexpected SYN packets, and then the NBA 31 selects the appropriate traversal technique accordingly. For instance, if the first NAT 13 or the second NAT 23 will directly drop an unexpected SYN packet, and if the SoSi TCP state tracking behavior test results show that the first NAT 13 or the second NAT 23 can receive a SYN packet sent from the second network device 21 or the first network device 11, the NBA 31 will instruct the network devices 11, 21 to use the SNT traversal technique. If the first NAT 13 or the second NAT 23 will reply with a RST packet, and if the SoRiSi TCP state tracking behavior test results show that the first NAT 13 or the second NAT 23 can receive a SYN packet sent from the second network device 21 or the first network device 11, the NBA 31 will instruct the network devices 11, 21 to use the SNT traversal technique. If the first NAT 13 or the second NAT 23 will reply with an ICMP Host Unreachable packet, and if the SoRiSi TCP state tracking behavior test results show that the first NAT 13 or the second NAT 23 can receive a SYN packet sent from the second network device 21 or the first network device 11, the NBA 31 will instruct the network devices 11, 21 to use the SNT traversal technique. If according to the SoSi, SoRiSi, and SoUiSi TCP state tracking behavior tests, neither the first NAT 13 nor the second NAT 23 can receive a SYN packet sent from the second network device 21 or the first network device 11, and yet the SoTiSi TCP state tracking behavior test results show that the first NAT 13 or the second NAT 23 can receive a SYN packet sent from the second network device 21 or the first network device 11, the NBA 31 will instruct the network devices 11, 21 to use the SLT traversal technique. If the aforesaid SoTiSi TCP state tracking behavior test results show that neither the first NAT 13 nor the second NAT 23 can receive a SYN packet sent from the second network device 21 or the first network device 11, the NBA 31 will instruct the network devices 11, 12 to use the Relay traversal technique instead.

In the foregoing preferred embodiment, it is the NBA 31 that selects the optimal traversal technique from a plurality of candidate traversal techniques (e.g., ESi, SNT, SLT, Relay) so as for the first network device 11 and the second network device 21 to establish a direct TCP connection therebetween. In a different embodiment, however, the NBA 31 can be configured in such a way that, upon receiving the information of the first NAT 13 and of the second NAT 23, the NBA 31 directly sends the information to the first network device 11 and/or the second network device 21, and it is the first network device 11 and/or the second network device 21 having received the information that analyzes the information and selects the optimal traversal technique from the plural candidate traversal techniques, before a direct TCP connection can be established between the first network device 11 and the second network device 21. Thus, once the first network device 11 and the second network device 21 have made their first TCP connection, and the NBA 31 has obtained the information of the NATs 13, 23, the NBA 31 or the network devices 11, 21 can rapidly find the optimal traversal technique from the plural candidate traversal techniques when the first network device 11 and the second network device 21 are to make TCP connection again. This makes it possible for the first network device 11 and the second network device 21 to rapidly make a direct TCP connection therebetween with the optimal traversal technique that allows the network devices 11, 21 to respectively and directly traverse the first NAT 13 and the second NAT 23. Compared with the conventional approach of performing a sequential connectivity check with initiator changes, the present invention eliminates the accumulation of test failure time and therefore shortens the total time required for making connection each time. Compared with the conventional approach of performing a parallel connectivity check with initiator changes, the present invention does not allow the use of several traversal techniques at the same time and therefore reduces the total amount of messages generated during tests. It is to be understood that the embodiments described above are merely the preferred embodiments of the present invention and should not be construed as restrictive of the scope of the present invention. All equivalent changes which are based on the technical disclosure of the present invention and readily conceivable by a person skilled in the art should be encompassed by the appended claims.

What is claimed is:

1. A method for establishing Transmission Control Protocol (TCP) connection according to network address translator (NAT) behaviors, the method being applicable to a network system comprising a first network device, a first NAT, a second network device, a second NAT, and a NAT behavior aware server (NBA), wherein the first network device and the first NAT are located in a first private network and connected to each other, the second network device and the second NAT are located in a second private network and connected to each other, and the first NAT and the second NAT are respectively connectable with the NBA, which is in the Internet, the method comprising the steps, in order for the first network device and the second network device to establish a direct TCP connection therebetween, of:
sending a plurality of testing messages to the NBA by each of the first network device and the second network device through a corresponding one of the first NAT and the second NAT;
sending reply messages to each of the first network device and the second network devices by the NBA according to the testing messages received, so as to test behaviors of the first NAT and of the second NAT respectively;
generating test result messages by each of the first network device and the second network device according to whether each corresponding said reply message is received and according to contents of each said reply message received, and sending the test result messages to the NBA by the first network device and the second network device respectively; and
reading from the test result messages information of the first NAT and of the second NAT, by the NBA upon receipt of the test result messages; storing the information of the NATs by the NBA; selecting an optimal traversal technique from a plurality of candidate traversal techniques, by the NBA according to the information of the NATs; and generating and sending a traversal message to each of the first network device and the second network device by the NBA, so as for the first network device and the second network device to respectively traverse the first NAT and the second NAT according to contents of the traversal messages and thereby establish the TCP connection between the first network device and the second network device.

2. The method of claim 1, wherein the NBA is provided with a network interface having two public Internet Protocol (IP) addresses, one said IP address using a first port and a second port of the NBA, the other IP address using a third port of the NBA, the NBA receiving the testing messages from the first NAT and the second NAT and sending the reply messages to the first network device and the second network device via the first port, the second port, and the third port; and wherein the testing messages sent by the first network device and the second network device are used to test mapping behaviors, filtering behaviors, and TCP state tracking behaviors of the first NAT and of the second NAT respectively.

3. The method of claim 1, further comprising the steps, for testing the mapping behaviors of the first NAT and of the second NAT, of:
sending three binding requests to the first port, the second port, and the third port respectively, by each of the first network device and the second network device through the corresponding one of the first NAT and the second NAT according to the two public IP addresses of the NBA;
replying to each of the first network device and the second network device with three binding responses by the NBA, upon receipt of the binding requests, from the first port, the second port, and the third port respectively; and
determining, by each of the first network device and the second network device according to corresponding said three binding responses, whether the mapping behavior of the corresponding NAT is independent, address dependent, or port and address dependent.

4. The method of claim 3, wherein the filtering behaviors comprise ESI filtering behaviors and Si filtering behaviors, and the method further comprises the steps, for testing the ESi filtering behaviors of the first NAT and of the second NAT, of:
establishing, by each of the first network device and the second network device, TCP connection with one of the public IP addresses of the NBA, wherein each of the first NAT and the second NAT uses a port for sending and receiving packets;
sending a Synchronize/Start (SYN) packet to each of the first network device and the second network device, by the NBA from the other public IP address thereof, wherein the SYN packets are to be delivered through the ports of the first NAT and of the second NAT respectively;
determining that the filtering behavior of the first NAT or of the second NAT allows the packet sequence of “establishment then inbound SYN”, if the first network device or the second network device receives a corresponding said SYN packet; and
determining that the filtering behavior of the first NAT or of the second NAT does not allow the packet sequence of “establishment then inbound SYN”, if the first network device or the second network device does not receive the corresponding SYN packet.

5. The method of claim 4, wherein the NBA further sends another SYN packet to an unopened port of each of the first network device and the second network device, so as to test whether the Si filtering behavior of each of the first NAT and the second NAT is directly dropping the another SYN packet, replying with a Reset (RST) request, or replying with an ICMP Host Unreachable packet.

6. The method of claim 5, wherein each of the first network device and the second network device tests a TCP state tracking behavior of the corresponding one of the first NAT and the second NAT by a SoSi TCP state tracking behavior test, a SoRiSi TCP state tracking behavior test, a SoUiSi TCP state tracking behavior test, and a SoTiSi TCP state tracking behavior test.

7. The method of claim 6, further comprising the steps, for conducting the SoSi TCP state tracking behavior tests, of:
sending a first SYN packet to the NBA by each of the first network device and the second network device through the corresponding one of the first NAT and the second NAT;
replying to each of the first network device and the second network device with a second SYN packet by the NBA upon receipt of the first SYN packets, wherein the second SYN packets are to be delivered through the first NAT and the second NAT respectively;
determining that the first NAT or the second NAT allows the packet sequence of “SYN-out SYN-in”, if the first network device or the second network device receives a corresponding said second SYN packet; and
determining that the first NAT or the second NAT does not allow the packet sequence of “SYN-out SYN-in”, if the first network device or the second network device does not receive the corresponding said second SYN packet.

8. The method of claim 7, further comprising the steps, for conducting the SoRiSi TCP state tracking behavior tests, of:
sending a third SYN packet to the NBA by each of the first network device and the second network device through the corresponding one of the first NAT and the second NAT;
replying to each of the first NAT and the second NAT with a RST request by the NBA upon receipt of the third SYN packets, and then replying to each of the first network device and the second network device with a fourth SYN packet by the NBA, wherein the fourth SYN packets are to be delivered through the first NAT and the second NAT respectively;
determining that the first NAT or the second NAT allows the packet sequence of “SYN-out RST-in SYN-in”, if the first network device or the second network device receives a corresponding said fourth SYN packet; and
determining that the first NAT or the second NAT does not allow the packet sequence of “SYN-out RST-in SYN-in”, if the first network device or the second network device does not receive the corresponding said fourth SYN packet.

9. The method of claim 8, further comprising the steps, for conducting the SoUiSi TCP state tracking behavior tests, of:
sending a fifth SYN packet to the NBA by each of the first network device and the second network device through the corresponding one of the first NAT and the second NAT;
replying to each of the first NAT and the second NAT with an ICMP Host Unreachable packet by the NBA upon receipt of the fifth SYN packets, and then replying to each of the first network device and the second network device with a sixth SYN packet by the NBA, wherein the sixth SYN packets are to be delivered through the first NAT and the second NAT respectively;
determining that the first NAT or the second NAT allows the packet sequence of “SYN-out UNR-in SYN-in”, if the first network device or the second network device receives a corresponding said sixth SYN packet; and
determining that the first NAT or the second NAT does not allow the packet sequence of “SYN-out UNR-in SYN-in”, if the first network device or the second network device does not receive the corresponding said sixth SYN packet.

10. The method of claim 9, further comprising the steps, for conducting the SoTiSi TCP state tracking behavior tests, of:
sending a seventh SYN packet to the NBA by each of the first network device and the second network device through the corresponding one of the first NAT and the second NAT;
replying to each of the first NAT and the second NAT with an ICMP Time-to-Live (TTL)-Expired packet by the NBA upon receipt of the seventh SYN packets, and then replying to each of the first network device and the second network device with an eighth SYN packet by the NBA, wherein the eighth SYN packets are to be delivered through the first NAT and the second NAT respectively;
determining that the first NAT or the second NAT allows the packet sequence of “SYN-out TTL-in SYN-in”, if the first network device or the second network device receives a corresponding said eighth SYN packet; and
determining that the first NAT or the second NAT does not allow the packet sequence of “SYN-out TTL-in SYN-in”, if the first network device or the second network device does not receive the corresponding said eighth SYN packet.

11. The method of claim 10, wherein the plural candidate traversal techniques comprise an ESi traversal technique, an SNT traversal technique, an SLT traversal technique, and a Relay traversal technique.

12. The method of claim 11, wherein where more than one of the candidate traversal techniques are applicable to either of the first NAT and the second NAT, application of the applicable candidate traversal techniques is based on the descending order of priority of: the ESi traversal technique, the SNT traversal technique, the SLT traversal technique, and the Relay traversal technique.

13. The method of claim 12, wherein if the NBA determines that the filtering behavior of the first NAT or of the second NAT allows the packet sequence of “establishment then inbound SYN”, the second network device or the first network device is made to send a SYN packet to the first network device or the second network device.

14. The method of claim 12, wherein if the NBA determines that the filtering behavior of neither the first NAT nor the second NAT allows the packet sequence of “establishment then inbound SYN” and that the mapping behavior of the first NAT or the second NAT is randomly dependent, the first network device and the second network device use the Relay traversal technique.

15. The method of claim 14, wherein if the NBA determines that the mapping behavior of neither the first NAT nor the second NAT is randomly dependent and that the Si filtering behavior of either the first NAT or the second NAT is directly dropping the another SYN packet, and if the SoSi TCP state tracking behavior tests end up with receipt of a said second SYN packet, the first network device and the second network device use the SNT traversal technique.

16. The method of claim 14, wherein if the NBA determines that the mapping behavior of neither the first NAT nor the second NAT is randomly dependent and that the Si filtering behavior of either the first NAT or the second NAT is replying with a Reset request, and if the SoRiSi TCP state tracking behavior tests end up with receipt of a said fourth SYN packet, the first network device and the second network device use the SNT traversal technique.

17. The method of claim 14, wherein if the NBA determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with receipt of a said sixth SYN packet, the first network device and the second network device use the SNT traversal technique.

18. The method of claim 14, wherein if the NBA determines that the mapping behavior of neither the first NAT nor the second NAT is randomly dependent and that the Si filtering behavior of either the first NAT or the second NAT is dropping the another SYN packet, and if the SoSi TCP state tracking behavior tests end up with non-receipt of any of the second SYN packets, and if the SoTiSi TCP state tracking behavior tests end up with receipt of a said eighth SYN packet, the first network device and the second network device use the SLT traversal technique.

19. The method of claim 14, wherein if the NBA determines that the mapping behavior of neither the first NAT nor the second NAT is randomly dependent and that the Si filtering behavior of either the first NAT or the second NAT is replying with a RST request, and if the SoRiSi TCP state tracking behavior tests end up with non-receipt of any of the fourth SYN packets, and if the SoTiSi TCP state tracking behavior tests end up with receipt of a said eighth SYN packet, the first network device and the second network device use the SLT traversal technique.

20. The method of claim 14, wherein if the NBA determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with non-receipt of any of the sixth SYN packets, and if the SoTiSi TCP state tracking behavior tests end up with receipt of a said eighth SYN packet, the first network device and the second network device use the SLT traversal technique.

21. The method of claim 14, wherein if the NBA determines that the mapping behavior of neither the first NAT nor the second NAT is randomly dependent and that the Si filtering behavior of either the first NAT or the second NAT is directly dropping the another SYN packet, and if the SoSi TCP state tracking behavior tests end up with non-receipt of any of the second SYN packets, and if the SoTiSi TCP state tracking behavior tests end up with non-receipt of any of the eighth SYN packets, the first network device and the second network device use the Relay traversal technique.

22. The method of claim 14, wherein if the NBA determines that the mapping behavior of neither the first NAT nor the second NAT is randomly dependent and that the Si filtering behavior of either the first NAT or the second NAT is replying with a RST request, and if the SoRiSi TCP state tracking behavior tests end up with non-receipt of any of the fourth SYN packets, and if the SoTiSi TCP state tracking behavior tests end up with non-receipt of any of the eighth SYN packets, the first network device and the second network device use the Relay traversal technique.

23. The method of claim 14, wherein if the NBA determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with non-receipt of any of the sixth SYN packets, and if the SoTiSi TCP state tracking behavior tests end up with non-receipt of any of the eighth SYN packets, the first network device and the second network device use the Relay traversal technique.

24. A method for establishing Transmission Control Protocol (TCP) connection according to network address translator (NAT) behaviors, the method being applicable to a network system comprising a first network device, a first NAT, a second network device, a second NAT, and a NAT behavior aware server (NBA), wherein the first network device and the first NAT are located in a first private network and connected to each other, the second network device and the second NAT are located in a second private network and connected to each other, and the first NAT and the second NAT are respectively connectable with the NBA, which is in the Internet, the method comprising the steps, in order for the first network device and the second network device to establish a direct TCP connection therebetween, of sending a plurality of testing messages to the NBA by each of the first network device and the second network device through a corresponding one of the first NAT and the second NAT;
sending reply messages to each of the first network device and the second network devices by the NBA according to the testing messages received, so as to test behaviors of the first NAT and of the second NAT respectively;
generating test result messages by each of the first network device and the second network device according to whether each corresponding said reply message is received and according to contents of each said reply message received, and sending the test result messages to the NBA by the first network device and the second network device respectively;
reading from the test result messages information of the first NAT and of the second NAT, by the NBA upon receipt of the test result messages; and sending the information of the NATs to the first network device and/or the second network device by the NBA; and
selecting an optimal traversal technique from a plurality of candidate traversal techniques according to the information of the NATs, by the first network device and/or the second network device having received the information of the NATs, so as for the first network device and the second network device to respectively traverse the first NAT and the second NAT by the optimal traversal technique and thus establish the TCP connection between the first network device and the second network device.

25. The method of claim 24, wherein the NBA is provided with a network interface having two public Internet Protocol (IP) addresses, one said IP address using a first port and a second port of the NBA, the other IP address using a third port of the NBA, the NBA receiving the testing messages from the first NAT and the second NAT and sending the reply messages to the first network device and the second network device via the first port, the second port, and the third port; and wherein the testing messages sent by the first network device and the second network device are used to test mapping behaviors, filtering behaviors, and TCP state tracking behaviors of the first NAT and of the second NAT respectively.

26. The method of claim 24, further comprising the steps, for testing the mapping behaviors of the first NAT and of the second NAT, of:
sending three binding requests to the first port, the second port, and the third port respectively, by each of the first network device and the second network device through the corresponding one of the first NAT and the second NAT according to the two public IP addresses of the NBA;
replying to each of the first network device and the second network device with three binding responses by the NBA, upon receipt of the binding requests, from the first port, the second port, and the third port respectively; and
determining, by each of the first network device and the second network device according to corresponding said three binding responses, whether the mapping behavior of the corresponding NAT is independent, address dependent, or port and address dependent.

27. The method of claim 26, wherein the filtering behaviors comprise ESi filtering behaviors and Si filtering behaviors, and the method further comprises the steps, for testing the ESi filtering behaviors of the first NAT and of the second NAT, of:
establishing, by each of the first network device and the second network device, TCP connection with one of the public IP addresses of the NBA, wherein each of the first NAT and the second NAT uses a port for sending and receiving packets;
sending a Synchronize/Start (SYN) packet to each of the first network device and the second network device, by the NBA from the other public IP address thereof, wherein the SYN packets are to be delivered through the ports of the first NAT and of the second NAT respectively;
determining that the filtering behavior of the first NAT or of the second NAT allows the packet sequence of “establishment then inbound SYN”, if the first network device or the second network device receives a corresponding said SYN packet; and
determining that the filtering behavior of the first NAT or of the second NAT does not allow the packet sequence of “establishment then inbound SYN”, if the first network device or the second network device does not receive the corresponding SYN packet.

28. The method of claim 27, wherein the NBA further sends another SYN packet to an unopened port of each of the first network device and the second network device, so as to test whether the Si filtering behavior of each of the first NAT and the second NAT is directly dropping the another SYN packet, replying with a Reset (RST) request, or replying with an ICMP Host Unreachable packet.

29. The method of claim 28, wherein each of the first network device and the second network device tests a TCP state tracking behavior of the corresponding one of the first NAT and the second NAT by a SoSi TCP state tracking behavior test, a SoRiSi TCP state tracking behavior test, a SoUiSi TCP state tracking behavior test, and a SoTiSi TCP state tracking behavior test.

30. The method of claim 29, further comprising the steps, for conducting the SoSi TCP state tracking behavior tests, of:
sending a first SYN packet to the NBA by each of the first network device and the second network device through the corresponding one of the first NAT and the second NAT;
replying to each of the first network device and the second network device with a second SYN packet by the NBA upon receipt of the first SYN packets, wherein the second SYN packets are to be delivered through the first NAT and the second NAT respectively;
determining that the first NAT or the second NAT allows the packet sequence of “SYN-out SYN-in”, if the first network device or the second network device receives a corresponding said second SYN packet; and
determining that the first NAT or the second NAT does not allow the packet sequence of “SYN-out SYN-in”, if the first network device or the second network device does not receive the corresponding said second SYN packet.

31. The method of claim 30, further comprising the steps, for conducting the SoRiSi TCP state tracking behavior tests, of:
sending a third SYN packet to the NBA by each of the first network device and the second network device through the corresponding one of the first NAT and the second NAT;
replying to each of the first NAT and the second NAT with a RST request by the NBA upon receipt of the third SYN packets, and then replying to each of the first network device and the second network device with a fourth SYN packet by the NBA, wherein the fourth SYN packets are to be delivered through the first NAT and the second NAT respectively;
determining that the first NAT or the second NAT allows the packet sequence of “SYN-out RST-in SYN-in”, if the first network device or the second network device receives a corresponding said fourth SYN packet; and
determining that the first NAT or the second NAT does not allow the packet sequence of “SYN-out RST-in SYN-in”, if the first network device or the second network device does not receive the corresponding said fourth SYN packet.

32. The method of claim 31, further comprising the steps, for conducting the SoUiSi TCP state tracking behavior tests, of:
sending a fifth SYN packet to the NBA by each of the first network device and the second network device through the corresponding one of the first NAT and the second NAT;
replying to each of the first NAT and the second NAT with an ICMP Host Unreachable packet by the NBA upon receipt of the fifth SYN packets, and then replying to each of the first network device and the second network device with a sixth SYN packet by the NBA, wherein the sixth SYN packets are to be delivered through the first NAT and the second NAT respectively;
determining that the first NAT or the second NAT allows the packet sequence of “SYN-out UNR-in SYN-in”, if the first network device or the second network device receives a corresponding said sixth SYN packet; and
determining that the first NAT or the second NAT does not allow the packet sequence of “SYN-out UNR-in SYN-in”, if the first network device or the second network device does not receive the corresponding said sixth SYN packet.

33. The method of claim 32, further comprising the steps, for conducting the SoTiSi TCP state tracking behavior tests, of:
sending a seventh SYN packet to the NBA by each of the first network device and the second network device through the corresponding one of the first NAT and the second NAT;
replying to each of the first NAT and the second NAT with an ICMP Time-to-Live (TTL)-Expired packet by the NBA upon receipt of the seventh SYN packets, and then replying to each of the first network device and the second network device with an eighth SYN packet by the NBA, wherein the eighth SYN packets are to be delivered through the first NAT and the second NAT respectively;
determining that the first NAT or the second NAT allows the packet sequence of “SYN-out TTL-in SYN-in”, if the first network device or the second network device receives a corresponding said eighth SYN packet; and
determining that the first NAT or the second NAT does not allow the packet sequence of “SYN-out TTL-in SYN-in”, if the first network device or the second network device does not receive the corresponding said eighth SYN packet.

34. The method of claim 33, wherein the plural candidate traversal techniques comprise an ESi traversal technique, an SNT traversal technique, an SLT traversal technique, and a Relay traversal technique.

35. The method of claim 34, wherein where more than one of the candidate traversal techniques are applicable to either of the first NAT and the second NAT, application of the applicable candidate traversal techniques is based on the descending order of priority of: the ESi traversal technique, the SNT traversal technique, the SLT traversal technique, and the Relay traversal technique.

36. The method of claim 35, wherein if the first network device and/or the second network device determines that the filtering behavior of the first NAT or of the second NAT allows the packet sequence of “establishment then inbound SYN”, the second network device or the first network device is made to send a SYN packet to the first network device or the second network device.

37. The method of claim 35, wherein if the first network device and/or the second network device determines that the filtering behavior of neither the first NAT nor the second NAT allows the packet sequence of “establishment then inbound SYN” and that the mapping behavior of the first NAT or the second NAT is randomly dependent, the first network device and the second network device use the Relay traversal technique.

38. The method of claim 37, wherein if the first network device and/or the second network device determines that the mapping behavior of neither the first NAT nor the second NAT is randomly dependent and that the Si filtering behavior of either the first NAT or the second NAT is directly dropping the another SYN packet, and if the SoSi TCP state tracking behavior tests end up with receipt of a said second SYN packet, the first network device and the second network device use the SNT traversal technique.

39. The method of claim 37, wherein if the first network device and/or the second network device determines that the mapping behavior of neither the first NAT nor the second NAT is randomly dependent and that the Si filtering behavior of either the first NAT or the second NAT is replying with a Reset request, and if the SoRiSi TCP state tracking behavior tests end up with receipt of a said fourth SYN packet, the first network device and the second network device use the SNT traversal technique.

40. The method of claim 37, wherein if the first network device and/or the second network device determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with receipt of a said sixth SYN packet, the first network device and the second network device use the SNT traversal technique.

41. The method of claim 37, wherein if the first network device and/or the second network device determines that the mapping behavior of neither the first NAT nor the second NAT is randomly dependent and that the Si filtering behavior of either the first NAT or the second NAT is dropping the another SYN packet, and if the SoSi TCP state tracking behavior tests end up with non-receipt of any of the second SYN packets, and if the SoTiSi TCP state tracking behavior tests end up with receipt of a said eighth SYN packet, the first network device and the second network device use the SLT traversal technique.

42. The method of claim 37, wherein if the first network device and/or the second network device determines that the mapping behavior of neither the first NAT nor the second NAT is randomly dependent and that the Si filtering behavior of either the first NAT or the second NAT is replying with a RST request, and if the SoRiSi TCP state tracking behavior tests end up with non-receipt of any of the fourth SYN packets, and if the SoTiSi TCP state tracking behavior tests end up with receipt of a said eighth SYN packet, the first network device and the second network device use the SLT traversal technique.

43. The method of claim 37, wherein if the first network device and/or the second network device determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with non-receipt of any of the sixth SYN packets, and if the SoTiSi TCP state tracking behavior tests end up with receipt of a said eighth SYN packet, the first network device and the second network device use the SLT traversal technique.

44. The method of claim 37, wherein if the first network device and/or the second network device determines that the mapping behavior of neither the first NAT nor the second NAT is randomly dependent and that the Si filtering behavior of either the first NAT or the second NAT is directly dropping the another SYN packet, and if the SoSi TCP state tracking behavior tests end up with non-receipt of any of the second SYN packets, and if the SoTiSi TCP state tracking behavior tests end up with non-receipt of any of the eighth SYN packets, the first network device and the second network device use the Relay traversal technique.

45. The method of claim 37, wherein if the first network device and/or the second network device determines that the mapping behavior of neither the first NAT nor the second NAT is randomly dependent and that the Si filtering behavior of either the first NAT or the second NAT is replying with a RST request, and if the SoRiSi TCP state tracking behavior tests end up with non-receipt of any of the fourth SYN packets, and if the SoTiSi TCP state tracking behavior tests end up with non-receipt of any of the eighth SYN packets, the first network device and the second network device use the Relay traversal technique.

46. The method of claim 37, wherein if the first network device and/or the second network device determines that the mapping behavior of neither the first NAT nor the second NAT is randomly dependent and that the Si filtering behavior of either the first NAT or the second NAT is replying with an ICMP Host Unreachable packet, and if the SoUiSi TCP state tracking behavior tests end up with non-receipt of any of the sixth SYN packets, and if the SoTiSi TCP state tracking behavior tests end up with non-receipt of any of the eighth SYN packets, the first network device and the second network device use the Relay traversal technique.
